(19) United States
(12) Patent Application Publication
(10) Pub. No.: US 2023/0206779 A1
(43) Pub. Date: Jun. 29, 2023

(54) DIGITAL TWIN FOR RIG OPERATIONS

(71) Applicant: Nabors Drilling Technologies USA, Inc., Houston, TX (US)

(72) Inventors: Pradeep ANNAIYAPPA, Houston, TX (US); Malini MANOCHA, Cypress, TX (US)

(21) Appl. No.: 18/069,399

(22) Filed: Dec. 21, 2022

Related U.S. Application Data
(60) Provisional application No. 63/266,040, filed on Dec. 27, 2021.

(51) Int. Cl. G09B 9/00; G09B 25/02

(52) U.S. Cl. CPC G09B 9/00; G09B 25/02; E21B 41/00

(57) ABSTRACT

A method for simulating a rig operation that can include creating a digital twin of a rig based on a rig plan for assembling/disassembling a rig; simulating, via the digital twin, a list of tasks for assembly/disassembly of rig components to assemble/disassemble the rig at a rig site. Also, a method for simulating and performing a rig operation is provided that can include operations of creating a digital twin of a rig based on a rig plan for the rig, simulating, via the digital twin, the rig plan, where the rig plan can include a list of tasks for moving rig components of the rig, and simulating, via the digital twin, moving the rig components from a first location to a second location.

### CROSS-REFERENCE TO RELATED APPLICATION(S)

This application claims priority under 35 U.S.C. § 119(e) to U.S. Provisional Application No. 63/266,040, entitled “DIGITAL TWIN FOR RIG OPERATIONS,” by Pradeep ANNAIYAPPA et al., filed Dec. 27, 2021, which is assigned to the current assignee hereof and incorporated herein by reference in its entirety.

### TECHNICAL FIELD

The present invention relates, in general, to the field of equipment for drilling and processing of wells. More particularly, present embodiments relate to a system and method for simulating an operation of a rig, including set-up, break down, and transport of a rig used for a subterranean operation, such as drilling and processing of a well.

### BACKGROUND

During well construction operations, activities at a rig site can be organized according to a well plan. The well plan can be converted to a rig plan (i.e., rig specific well construction plan) for implementation on a specific rig. The well plan can include activities for performing a subterranean operation at the rig site. However, when operations at a first rig site are complete, the rig (including support equipment) can be disassembled at the first rig site, transported to a second rig site, and reassembled at the second rig site to begin subterranean operations at the second rig site. Moving the rig from one site to another is a significant undertaking and while the rig is being moved, at least portions of the rig cannot be utilized in producing hydrocarbons from a subterranean formation. Therefore, improvements in moving a rig between rig sites are continually needed.

### SUMMARY

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus (e.g., one or more processors), cause the apparatus to perform the actions. One general aspect includes a method for simulating a rig operation which can include creating a digital twin of a rig based on a rig plan for assembling a rig (and possibly at least partially operating the rig during the assembling); simulating, via the digital twin, the rig plan, where the rig plan may include a list of tasks for assembly of rig components to assemble the rig (and possibly operate at least a portion of the rig); and simulating, via the digital twin, assembly of the rig components at a rig site. Other embodiments of this aspect include corresponding computer systems, apparatus, and computer programs recorded on one or more computer storage devices, each configured to perform the actions of the methods.

One general aspect includes a method for simulating a rig operation. The method can include creating a digital twin of a rig based on a rig plan for disassembling a rig (and possibly at least partially operating the rig during the disassembling); simulating, via the digital twin, the rig plan, where the rig plan may include a list of tasks for assembly of rig components to assemble the rig (and possibly operate at least a portion of the rig); and simulating, via the digital twin, disassembly of the rig components at a rig site. Other embodiments of this aspect include corresponding computer systems, apparatus, and computer programs recorded on one or more computer storage devices, each configured to perform the actions of the methods.

One general aspect includes a method for simulating and performing a rig operation. The method can include creating a digital twin of a rig based on a rig plan for the rig; simulating, via the digital twin, the rig plan, where the rig plan may include a list of tasks for moving rig components of the rig; and simulating, via the digital twin, moving the rig components from a first location to a second location. Other embodiments of this aspect include corresponding computer systems, apparatus, and computer programs recorded on one or more computer storage devices, each configured to perform the actions of the methods.

### BRIEF DESCRIPTION OF THE DRAWINGS

These and other features, aspects, and advantages of present embodiments will become better understood when the following detailed description is read with reference to the accompanying drawings in which like characters represent like parts throughout the drawings, wherein:

FIG. 1A is a representative simplified front view of a rig being utilized for a subterranean operation, in accordance with certain embodiments;

FIG. 1B is a representative simplified view of an individual (or user) using wearable devices for user input or identification, in accordance with certain embodiments;

FIG. 2 is a representative partial cross-sectional view of a rig being utilized for a subterranean operation, in accordance with certain embodiments;

FIG. 3 is a representative front view of various individuals identifiable via an imaging system, in accordance with certain embodiments;

FIG. 4A is a representative list of activities for an example digital well plan, in accordance with certain embodiments;

FIG. 4B is a representative functional diagram that illustrates the conversion of well plan activities to rig plan tasks, in accordance with certain embodiments;

FIG. 5 is a representative functional diagram that illustrates possible databases used by a rig controller to convert a digital well plan to a digital rig plan, in accordance with certain embodiments;

FIGS. 6A-6B are representative functional diagrams that illustrate methods for simulating rig operations via a digital twin, in accordance with certain embodiments;

FIGS. 7A-7E are representative simplified front view of a rig in various stages of assembly at a rig site with a corresponding display of a digital twin simulation, in accordance with certain embodiments; and

FIGS. 8 and 9 is a representative view of a human machine interface (HMI) that can be used to interact with an individual while displaying information and images of a digital twin, in accordance with certain embodiments.

### DETAILED DESCRIPTION

The following description in combination with the figures is provided to assist in understanding the teachings disclosed herein. The following discussion will focus on specific implementations and embodiments of the teachings. This focus is provided to assist in describing the teachings and should not be interpreted as a limitation on the scope or applicability of the teachings.

As used herein, the terms “comprises,” “comprising,” “includes,” “including,” “has,” “having,” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus. Further, unless expressly stated to the contrary, “or” refers to an inclusive-or and not to an exclusive-or. For example, a condition A or B is satisfied by any one of the following: A is true (or present), and B is false (or not present), A is false (or not present), and B is true (or present), and both A and B are true (or present).

The use of “a” or “an” is employed to describe elements and components described herein. This is done merely for convenience and to give a general sense of the scope of the invention. This description should be read to include one or at least one and the singular also includes the plural, or vice versa, unless it is clear that it is meant otherwise.

The use of the word “about”, “approximately”, or “substantially” is intended to mean that a value of a parameter is close to a stated value or position. However, minor differences may prevent the values or positions from being exactly as stated. Thus, differences of up to ten percent (10%) for the value are reasonable differences from the ideal goal of exactly as described. A significant difference can be when the difference is greater than ten percent (10%).

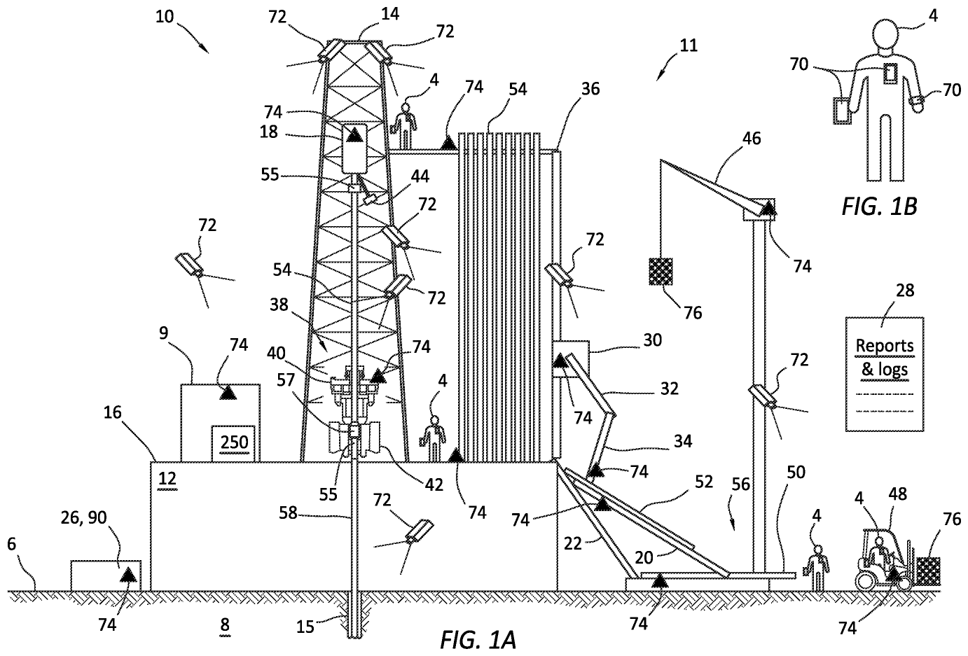

As used herein, “tubular” refers to an elongated cylindrical tube and can include any of the tubulars manipulated around a rig, such as tubular segments, tubular stands, tubulars, and tubular string, but not limited to the tubulars shown in FIG. 1A. Therefore, in this disclosure, “tubular” is synonymous with “tubular segment,” “tubular stand,” and “tubular string,” as well as “pipe,” “pipe segment,” “pipe stand,” “pipe string,” “casing,” “casing segment,” or “casing string.”

FIG. 1A is a representative simplified front view of a rig 10 at a rig site 11 being utilized for a subterranean operation (e.g., tripping in or out a tubular string to or from a wellbore), in accordance with certain embodiments. The rig site 11 can include the rig 10 with its rig equipment, along with equipment and work areas that support the rig 10 but are not necessarily on the rig 10. The rig 10 can include a platform 12 with a rig floor 16 and a derrick 14 extending up from the rig floor 16. The derrick 14 can provide support for hoisting the top drive 18 as needed to manipulate tubulars. A catwalk 20 and V-door ramp 22 can be used to transfer horizontally stored tubular segments 50 to the rig floor 16. A tubular segment 52 can be one of the horizontally stored tubular segments 50 that is being transferred to the rig floor 16 via the catwalk 20. A pipe handler 30 with articulating arms 32, 34 can be used to grab the tubular segment 52 from the catwalk 20 and transfer the tubular segment 52 to the top drive 18, the fingerboard 36, the wellbore 15, etc. However, it is not required that a pipe handler 30 be used on the rig 10. The top drive 18 can transfer tubulars directly to and directly from the catwalk 20 (e.g., using an elevator 44 coupled to the top drive 18). Also, a catwalk 20 is not required, since one or more pipe handlers 30 can be used to transfer tubulars between storage locations (horizontal or vertical) and a well center.

FIG. 1A shows a land-based rig. However, it should be understood that the principles of this disclosure are equally applicable to off-shore rigs where “off-shore” refers to a rig with water between the rig floor and the earth surface 6.

When tripping the tubular string 58 out of the wellbore 15, tubulars 54 can be sequentially removed from the tubular string 58 to reduce the length of the tubular string 58 in the wellbore 15. The pipe handler 30 can be used to remove the tubulars 54 from an iron roughneck 38 or a top drive 18 at a well center 24 and transfer the tubulars 54 to the catwalk 20, the fingerboard 36, other storage locations, etc. The iron roughneck 38 can break a threaded connection between a tubular 54 being removed and the tubular string 58. A spinner assembly 40 (or pipe handler 30) can engage a body of the tubular 54 to spin a pin end 57 of the tubular 54 out of a threaded box end 55 of the tubular string 58, thereby unthreading the tubular 54 from the tubular string 58.

When tripping the tubular string 58 into the wellbore 15, tubulars 54 are sequentially added to the tubular string 58 to increase the length of the tubular string 58 in the wellbore 15 extending through the surface 6 into the subterranean formation 8. The pipe handler 30 can be used to deliver the tubulars 54 to a well center on the rig floor 16 in a vertical orientation and hand the tubulars 54 off to an iron roughneck 38 or a top drive 18. The iron roughneck 38 can make a threaded connection between the tubular 54 being added and the tubular string 58. A spinner assembly 40 or pipe handler 30 can engage a body of the tubular 54 to spin a pin end 57 of the tubular 54 into a threaded box end 55 of the tubular string 58, thereby threading the tubular 54 into the tubular string 58. The wrench assembly 42 can provide a desired torque to the threaded connection, thereby completing the connection.

While tripping a tubular string into or out of the wellbore 15 can be a significant part of the operations performed by the rig and individual drillers, many other rig tasks are also needed to perform a well construction according to a digital well plan. For example, pumping mud at desired rates, maintaining downhole pressures (as in managed pressure drilling), maintaining and controlling rig power systems, maintaining and controlling rig equipment including downhole equipment to perform the subterranean operation, coordinating and managing personnel on the rig during the subterranean operation, performing pressure tests on sections of the wellbore 15, cementing a casing string in the wellbore 15, performing well logging operations, as well as many other rig tasks. As used herein, “personnel”, “individual”, “user”, or “operator” can be used interchangeably in that each refers to a human that is available to support a subterranean operation.

A rig controller 250 can control the rig 10 operations including controlling various rig equipment, such as the pipe handler 30, the top drive 18, the iron roughneck 38, the fingerboard equipment, imaging systems, various other robots on the rig 10 (e.g., a drill floor robot), rig power systems 26 (which can include an energy storage system ESS 90) or instructing individuals 4 on the rig 10. The rig controller 250 can control the rig equipment autonomously (e.g., without periodic operator interaction), semi-autonomously (e.g., with limited individual interaction such as initiating a subterranean operation, adjusting parameters during the operation, etc.), or manually (e.g., with the individual interactively controlling the rig equipment via remote control interfaces to perform the subterranean operation).

The rig controller 250 can include one or more processors with one or more of the processors distributed about the rig 10, such as in a control hut 9, in the pipe handler 30, in the iron roughneck 38, in the vertical storage area 36, in the imaging systems, in various other robots, in the top drive 18, at various locations on the rig floor 16 or the derrick 14 or the platform 12, at a remote location off of the rig 10, at downhole locations, etc. It should be understood that any of these processors, including processors in downhole locations, can perform control or calculations locally and report the results to the surface equipment, or can communicate to a remotely located processor for performing the control or calculations. Each of the processors can be communicatively coupled to a non-transitory memory, which can include instructions for the respective processor to read and execute to implement the desired control function as well as methods included in this disclosure. These processors can be coupled via a wired or wireless network. All data received and sent by the rig controller 250 is in a computer-readable format and can be stored in and retrieved from the non-transitory memory.

The rig controller 250 can collect data from various data sources around the rig (e.g., surface, and downhole sensors, user input, local rig reports, etc.) and from remote data sources (e.g., suppliers, manufacturers, transporters, company men, remote rig reports, etc.) to monitor and facilitate the execution of a digital well plan under the supervision of one or more individual drillers. A digital well plan 100 is generally designed to be independent of a specific rig, where a digital rig plan 102 is a digital well plan 100 that has been modified to incorporate the specific equipment available on a specific rig to execute the well plan on the specific rig, such as rig 10. Therefore, the rig controller 250 can be configured to monitor and facilitate the execution of the digital well plan 100 by monitoring and executing the digital rig plan 102.

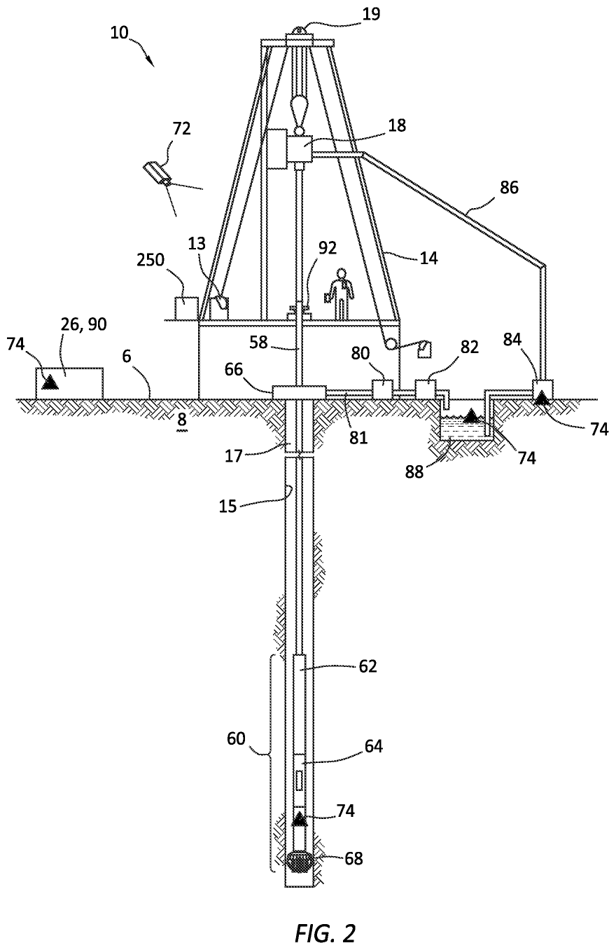

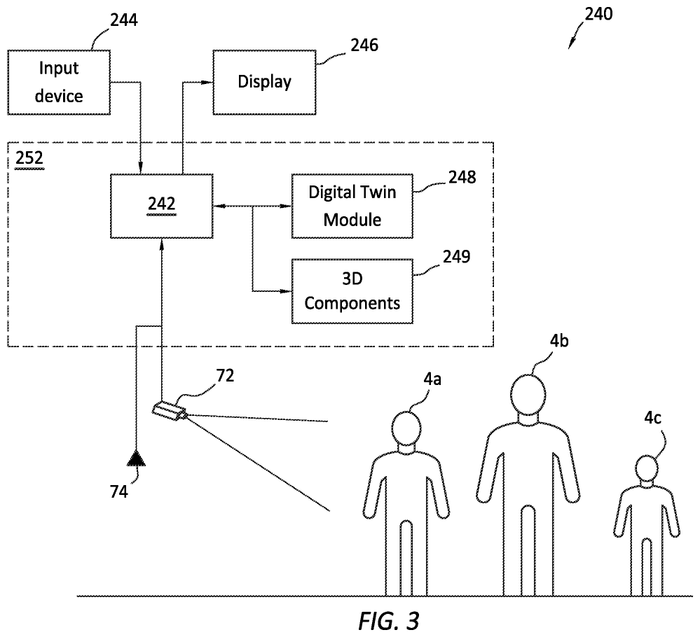

Examples of local data sources are shown in FIG. 1A where an imaging system (e.g., imaging system 240 in FIG. 3) can include the rig controller 250 and imaging sensors 72 positioned at desired locations around the rig and around support equipment/material areas, such as mud pumps (see FIG. 2), horizontal storage area 56, power system 26, etc., to collect imagery of the desired locations. Also, various sensors 74 can be positioned at various locations around the rig site 11 and the support equipment/material areas to collect information from the rig equipment (e.g., pipe handler 30, roughneck 38, top drive 18, vertical storage 36, BHA 60, logging tool 64, etc.) and support equipment (e.g., crane 46, forklift 48, horizontal storage area 56, power system 26, shaker 80, return line 81, fluid treatment 82, pumps 84, stand line 86, mud pit 88, handlers for material 76, etc.) to collect operational parameters of the equipment. As used herein, “rig equipment” refers to equipment used at the rig site 11, either on or off the rig 10 or downhole, which can include the support equipment described above. Additional information can be collected (via the rig controller 250 or via an individual 4) from other data sources, such as reports and logs 28 (e.g., tour reports, daily progress reports, reports from remote locations, shipment logs, delivery logs, personnel logs, etc.).

The data sources can also include wearables 70 (e.g., a smart wristwatch, a smart phone, a tablet, a laptop, an identification badge, a wearable transmitter, etc.) that can be worn by an individual 4 (or user 4) to identify the individual 4, deliver instructions to the individual 4, or receive inputs from the individual 4 via the wearable 70 to the rig controller 250 (see FIG. 1B). Network connections (wired or wireless) to the wearables 70 can be used for communication between the rig controller 250 and the wearables 70 for information transfer.

FIG. 2 is a representative partial cross-sectional view of a rig 10 being used to drill a wellbore 15 in an earthen formation 8. FIG. 2 shows a land-based rig, but the principles of this disclosure can equally apply to off-shore rigs, as well. The rig 10 can include a top drive 18 with a traveling block 19 and drawworks 13 used to raise or lower the top drive 18. A derrick 14 extending from the rig floor, can provide the structural support of the rig equipment for performing subterranean operations (e.g., drilling, treating, completing, producing, testing, etc.). The rig 10 can be used to extend a wellbore 15 through the earthen formation 8 by using a drill string 58 having a Bottom Hole Assembly (BHA) 60 at its lower end. Slips 92 in coordination with the top drive 18 and drawworks 13 can trip in and trip out the tubular string 58. The BHA 60 can include a drill bit 68 and multiple drill collars 62, with one or more of the drill collars including instrumentation (e.g., logging tool 64) for LWD and MWD operations. During drilling operations, drilling mud can be pumped from the surface 6 into the drill string 58 (e.g., via pumps 84 supplying mud to the top drive 18) to cool and lubricate the drill bit 68 and to transport cuttings to the surface via an annulus 17 between the drill string 58 and the wellbore 15.

The returned mud can be directed from the rotating control device 66 (if used) to the mud pit 88 through the flow line 81 and the shaker 80. A fluid treatment 82 can inject additives as desired to the mud to condition the mud appropriately for the current well activities and possibly future well activities as the mud is being pumped to the mud pit 88. The pump 84 can pull mud from the mud pit 88 and drive it to the top drive 18 to continue circulation of the mud through the drill string 58.

Sensors 74 and imaging sensors 72 can be distributed about the rig and downhole to provide information on the environments in these areas as well as operating conditions, health of rig equipment and individuals 4, a well activity the equipment is performing, weight on bit (WOB), rate of penetration (ROP), revolutions per minute (RPM) of a drill string, RPM of a drill bit 68, downhole pressures, downhole temperatures, properties of the surrounding subterranean formation 8, depth of a wellbore 15, length of a tubular string 58, rheology of operational fluids, etc.

One or more rig components of the rig 10 can be organized into zones based on a function of the rig that the one or more rig components perform. These zones can be used to organize or optimize the disassembly or assembly of the rig 10 at the rig site 11. For example, equipment used to handle the circulation of mud can be a zone, equipment used to supply power to the rig 10 can be a zone, equipment used to raise and lower a tubular string 59 can be a zone, the derrick 14 can be a zone, the control hut 9 can be a zone, the horizontal storage area 56 can be a zone, the vertical storage area 36 can be a zone, crew quarters can be a zone, etc. The digital twin can use these identified zones of equipment to organize the disassembly of assembly of the rig 10 at the rig site 11.

FIG. 3 is a representative front view of various individuals 4a, 4b, 4c that can be detectable via an imaging system 240. The imaging system 240 can include the rig controller 250 and one or more imaging sensors 72 as well as other sensors 74, e.g., audio sensors. When determining the current well activity, it can be beneficial to detect how many individuals are present on the rig, where they are, who they are, and what they are doing. Also, simulations of rig operations can utilize specific individuals 4a, 4b, 4c (or others) along with rig equipment to simulate performance of activities of a digital well plan 100. Knowing, retrieving, or detecting characteristics of individuals 4a, 4b, 4c can be used to adjust the simulation of rig operations based on these characteristics. Also, the simulation can be adjusted to accommodate or take advantage of the individual's characteristics or change one or more individuals with more suitable candidates for the particular activities. One or more imaging sensors 72 can be used to detect identity and characteristics of each of individual 4. By receiving imagery from the one or more imaging sensors 72, the rig controller 250 can perform image recognition to detect the individuals (such as individuals 4a, 4b, 4c, etc.) in the imagery and compare the collected imagery (or LiDAR sensor data) to the simulation and identify how well the performance of the one or more individuals track the estimated performance given by the simulation.

The rig controller 250, via processors 242, can create a 3D model of the rig 10 based on 3D components of the rig equipment and individuals 4. The digital twin simulation can be a simulation that understands the constraints and goals of the rig operations (such as rig-up or rig-down) and emulates the tasks needed to perform the goals under the known constraints. The digital twin can be a simulator that uses the 3D model to visualize the rig operations as they can or are occurring. The digital twin can also be a simulator that generates a list for all activities or tasks to be performed with consideration for all constraints involved in the tasks. The list of all activities can include list subsets where each list subset can be executed in parallel or simultaneously with other list subsets. Also, some list subsets, such as for at least a portion of a rig-down operation, can be executed in parallel with tasks in a rig plan 102 while the rig plan tasks are being performed to complete a well plan 100. As used herein, “digital twin” refers to a simulation performed by the rig controller 250 of the rig operations.

The rig controller 250 can include a digital twin module 248 that can retrieve 3D components from a database 249 and create a full (or at least a partial) 3D model representation of the rig 10. The rig controller 250 can also retrieve information about the rig, recipes for performing tasks of a rig plan 102 to execute a rig-down or rig-up operation, available resources for performing the tasks, and co-dependencies of the resources and tasks to other resources and tasks of the rig plan 102. The rig controller 250 can use artificial intelligence, such as machine learning, based on established constraints of the rig 10, tasks to be performed, and available resources to perform the tasks to perform a simulation of the rig plan 102 (e.g., rig-down or rig-up operations).

The rig controller can then, via the digital twin module 248, run a simulation of rig operations to determine performance characteristics of the rig 10 (including one or more individuals and support equipment) compared to the digital rig plan 102. The rig operations can include one or more rig tasks of a digital rig plan 102, one or more activities of a digital well plan 100, or one or more operations to move the rig 10 to another rig site 11. The digital twin can be used to plan and coordinate the rig operations by allocating and evaluating the performance of individuals, rig equipment, organization, etc., to determine the best fit for rig resources based on a desired performance criteria (e.g., speed, efficiency, etc.) as well as the best organization of these resources (e.g., individuals or rig equipment) including tasks that can be performed in parallel with other tasks in the rig plan 102.

During the actual assembly, disassembly, or move of the rig, the rig plan 102 provides the organized set of tasks for performing the assembly, disassembly, or move of the rig, unplanned events may occur (e.g., equipment failure, a conveyance vehicle breaks down, fewer individuals available for the task, travel time of one or more conveyance vehicles is not as expected, components packed/unpacked out of sequence, etc.). The digital twin can be used, when the unplanned event is detected, to adjust the rig plan 102 to incorporate alternative tasks to reduce or eliminate impacts to the success of the overall rig plan 102. The digital twin can be used to evaluate many different sets of alternative tasks to determine one or more sets of alterative tasks that can be incorporated into the rig plan 102 to mitigate the impacts of the unplanned activity. As used herein, “assembly,” “disassembly,” or “transport (or move)” of the rig 10 can include operating at least a portion of the rig to support hydrocarbon production or to support the “assembly,” “disassembly,” or “transport” of the rig 10. Some rig equipment can be in transit while other rig equipment remain at the rig site 11 or while other rig equipment is being assembled at a new rig site 11. The rig equipment that has not yet been disassembled (or has already been assembled) may be operated to support rig operations, assembly, or disassembly. For example, pumps can continue to operate while the rig 10 is being disassembled or transported.

Via the digital twin, the performance of primary activities and secondary operations can be evaluated to verify that the secondary operations can be performed in a timely manner, so they do not become a primary activity. As used herein “primary activities” are those activities that are listed in the digital well plan, and as used herein “secondary operations” are those operations that provide support for the execution of the primary activities. Secondary operations can become primary activities if they do not adequately support the primary activities and cause delays in the primary activities by not being able to properly execute the primary activities. The digital twin can also determine which of the primary activities, secondary operations, or combinations of both can be performed simultaneously with other primary activities or secondary operations during assembly or disassembly of the rig. For example, when the tubular string 58 is being tripped out of the wellbore 15 for the last time, then disassembly of the mud pumps, mud lines, etc., can begin while the tubular string 58 is being removed from the wellbore 15. For example, when the tubular string 58 is being tripped out of the wellbore 15 for the last time, then disassembly of the vertical storage area 36 can begin while the tubular string 58 is being removed from the wellbore 15 and tubular segments 54 are delivered to the horizontal storage area 56.

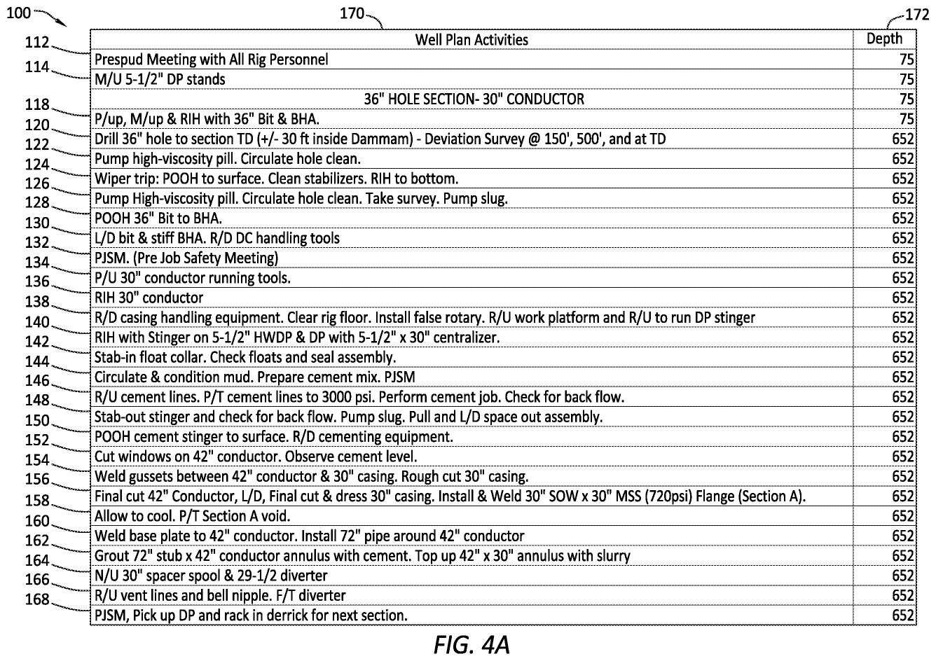

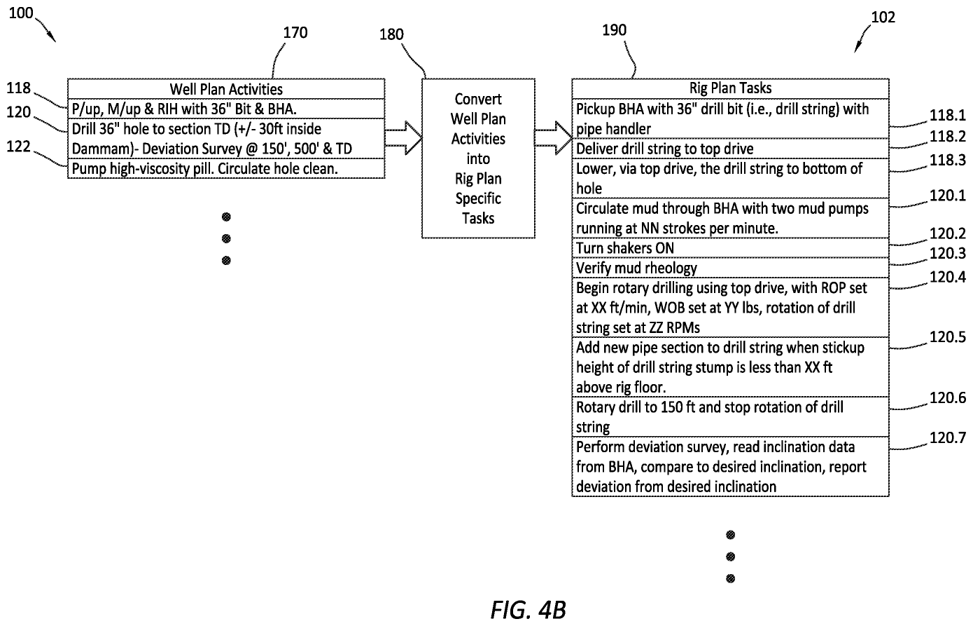

FIG. 4A is a representative list of activities 170 for an example digital well plan 100. This list of well plan activities 170 can merely represent a subset of a complete list of activities needed to execute a full digital well plan 100 to construct a wellbore 15 to a target depth (TD). The digital well plan 100 can include well plan activities 170 with corresponding target wellbore depths 172. However, these specific activities 170 are not required for the digital well plan 100. More or fewer activities 170 can be included in the digital well plan 100 in keeping with the principles of this disclosure. Therefore, the following discussion relates to the well plan activities 170 shown in FIG. 4A is merely an example to illustrate the concepts of this disclosure.

After the rig 10 has been utilized to drill the wellbore 15 to a depth of 75, at activity 112, a Prespud meeting can be held to brief all rig personnel on the goals of the digital well plan 100.

At activity 114, the appropriate personnel and rig equipment can be used to make-up (M/U) 5 ½″ drill pipe (DP) stands in prep for the upcoming drilling operation. This can for example require a pipe handler and horizontal or vertical storage areas for tubular segments or tubular stands. The primary activities can be seen as the make-up of the drill pipe (DP) stands, with the secondary operations being, for example, availability of tubular segments to build the DP stands; availability of a pipe handler (e.g., pipe handler 30) to manipulate the tubulars; a torquing wrench and backup tong for torquing joints when assembling the DP stands, a horizontal storage area, a vertical storage area; available space in a storage area for the DP stands; doping compound and doping device available for cleaning and doping threads of the tubulars 50; or appropriate personnel to support these operations.

At activity 118, the appropriate personnel and rig equipment can be used to pick up (P/up), makeup (M/up), and run-in hole (RIH) a BHA with a 36″ drill bit 68. This can, for example, require BHA components; a pipe handler to assist in the assembly of the BHA components; a pipe handler to deliver BHA to a top drive; and lowering the top drive to run the BHA into the wellbore 15. The primary activities can be seen as assembling the BHA and lowering the BHA into the wellbore 15. The secondary operations can be delivering the BHA components, including the drill bit, to the rig site; monitoring the health of the equipment to be used; and ensuring personnel available to perform tasks when needed.

At activity 120, the appropriate personnel and rig equipment can be used to drill 36″ hole to a TD of the section, such as 652 ft, to +/−30 ft inside a known formation layer (e.g., Dammam), and performing a deviation survey at depths of 150′, 500′ and TD (i.e., 652′ in this example). The primary activities can be seen as repeatedly feeding tubulars (or tubular stands 54) via a pipe handler to the well center from a tubular storage for connection to a tubular string 58 in the wellbore 15; operating the top drive 18, the iron roughneck 38, and slips to connect tubulars 50 (or tubular stands 54) to the tubular string 58; cleaning and doping threads of the tubulars 50, 54; running mud pumps to circulate mud through the tubular string 58 to the bit 68 and back up the annulus 17 to the surface; running shakers; injecting mud additives to condition the mud; rotating the tubular string 58 or a mud motor (not shown) to drive the drill bit 68, and performing deviation surveys at the desired depths.

The secondary operations can be seen as having tubulars 50 (or tubular stands 54) available in the horizontal storage or vertical storage locations and accessible via the pipe handler. If coming from the horizontal storage 56, then the tubulars 50 can be positioned on horizontal stands, with individuals 4 operating handling equipment, such as forklifts 48 or crane 46, to keep the storage area 56 stocked with the tubulars 50. If coming from the vertical storage 36, then the rig personnel 4 (or rig controller 250), can make sure that enough tubular stands 54 (or tubulars 50) are racked in the vertical storage 36 and accessible to the pipe handler 30 (or another pipe handler if needed). Additional secondary operations can be seen as ensuring that the doping compound and doping device are available for cleaning and doping threads of the tubulars 50; mud additives are available for an individual 4 (e.g., mud engineer) or an automated process to condition the mud as needed; the necessary equipment is available and operational to support the activity 120, such as the top drive 18 (including drawworks), iron roughneck 38, slips, and pipe handlers; and ensuring the power system 26 is configured to support the drilling operation.

At activity 122, the appropriate personnel and rig equipment can be used to pump a high-viscosity pill through the wellbore 15 via the tubular string 58 and then circulate wellbore 15 clean. The primary activities can be seen as injecting mud additives into the mud to create the high-viscosity pill, mud pumps operating to circulate the pill through the wellbore 15 (down through the tubular string 58 and up through the annulus 17); slips to hold tubular string 58 in place; top drive 18 connected to tubular string 58 to circulate mud; and, after pill is circulated, circulating mud through the wellbore 15 to clean the wellbore 15. The secondary operations can be ensuring the power system 26 is configured to support the mud circulation activities; the mud pumps 84 are configured to supply the desired pressure and flow rate of fluid to the tubular string 58; and that the mud additives are available for an individual 4 (e.g., mud engineer) or an automated process to condition the mud as needed.

At activity 124, the appropriate personnel and rig equipment can be used to perform a “wiper trip” by pulling the tubular string 58 out of the hole (Pull out of hole—POOH) to the surface 6; clean stabilizers on the tubular string 58; and run the tubular string 58 back into the hole (Run in hole—RIH) to the bottom of the wellbore 15. The primary activities can be seen as operating the top drive 18, the iron roughneck 38, and slips to disconnect tubulars 50 (or tubular stands 54) from the tubular string 58; moving the tubulars 50 (or tubular stands 54) to vertical storage 36 or horizontal storage 56 via a pipe handler, equipment and personnel/individuals 4 to clean the stabilizers; and operating the top drive 18, the iron roughneck 38, and slips to again connect tubulars 50 (or tubular stands 54) to the tubular string 58 while running the tubular string 58 back into the wellbore 15.

The secondary operations can be seen as having the necessary equipment to support the activity 124 is operational, such as the top drive 18 (including drawworks), iron roughneck 38, slips, and pipe handlers operational; ensuring the power system 26 is configured to support the tripping out and tripping in operations; and ensuring that the appropriate individual(s) 4 and cleaning equipment are available to perform stabilizer cleaning when needed.

At activities 126 thru 168, the appropriate personnel and rig equipment can be used to perform the indicated well plan activities. The primary activities can be seen as the personnel, equipment, or materials needed to directly execute the well plan activities using the specific rig 10. The secondary operations can be those activities that ensure the personnel, equipment, or materials are available and configured to support the primary activities.

FIG. 4B is a functional diagram that can illustrate the conversion of well plan activities 170 to rig plan tasks 190 of a rig-specific digital rig plan 102. When a well plan 100 is designed, well plan activities 170 can be included to describe primary activities needed to construct a desired wellbore 15 to a TD. However, the well plan 100 activities 170 are not specific to a particular rig, such as rig 10. It may not be appropriate to use the well plan activities 170 to direct operations on a specific rig, such as rig 10. Therefore, a conversion of the well plan activities 170 can be performed to create a list of rig plan tasks 190 of a digital rig plan 102 to construct the desired wellbore 15 using a specific rig, such as rig 10. This conversion engine 180 (which can run on a computing system such as the rig controller 250) can take the non-rig specific well plan activities 170 as an input and convert each of the non-rig specific well plan activities 170 to a series of rig specific tasks 190 to create a digital rig plan 102 that can be used to direct activities on a specific rig, such as rig 10, to construct the desired wellbore 15.

As a way of example, a high-level description of the conversion engine 180 will be described for a subset of well plan activities 170 to demonstrate a conversion process to create the digital rig plan 102. The well plan activity 118 states, in abbreviated form, to pick up, make up, and run-in hole a BHA 60 with a 36″ drill bit. The conversion engine 180 can convert this single non-rig-specific activity 118 into, for example, three rig-specific tasks 118.1, 118.2, 118.3. Task 118.1 can instruct the rig operators or rig controller 250 to pick up the BHA 60 (which has been outfitted with a 36″ drill bit) with a pipe handler. At task 118.2, the pipe handler can carry the BHA 60 and deliver it to the top drive 18, with the top drive 18 using an elevator to grasp and lift the BHA 60 into a vertical position. At task 118.3, the top drive 18 can lower the BHA 60 into the wellbore 15 which has already been drilled to a depth of 75′ for this example as seen in FIG. 4A. The top drive 18 can lower the BHA 60 to the bottom of the wellbore 15 to have the drill bit 68 in position to begin drilling as indicated in the following well activity 120.

The well plan activity 120 states, in abbreviated form, to drill a 36″ hole to a target depth (TD) of the section, such as 652 ft, to +/−30 ft inside a known formation layer (e.g., Dammam), and performing a deviation survey at depths of 150′, 500′ and TD (i.e., 652′ in this example). The conversion engine 180 can convert this single non-rig-specific activity 120 into, for example, seven rig-specific tasks 120.1 to 120.7. Task 120.1 can instruct the rig operators or rig controller 250 to circulate mud through the top drive 18, through the drill string 58, through the BHA 60, and exiting the drill string 58 through the drill bit 68 into the annulus 17. For this example, the mud flow requires two mud pumps 84 to operate at “NN” strokes per minute, where “NN” is a desired value that delivers the desired mud flow and pressure. At task 120.2, the shaker tables can be turned on in preparation for cuttings that should be coming out of the annulus 17 when the drilling begins. At task 120.3, a mud engineer can verify that the mud characteristics are appropriate for the current tasks of drilling the wellbore 15. If the rheology indicates that mud characteristics should be adjusted, then additives can be added to adjust the mud characteristics as needed.

At task 120.4, rotary drilling can begin by lowering the drill bit into contact with the bottom of the wellbore 15 and rotating the drill bit by rotating the top drive 18 (e.g., rotary drilling). The drilling parameters can be set to be “XX” ft/min for the rate of penetration (ROP), “YY” lbs. for weight on bit (WOB), and “ZZ” revolutions per minute (RPM) of the drill bit 68.

At task 120.5, as the wellbore 15 is extended by the rotary drilling when the top end of the tubular string 58 is less than “WW” ft above the rig floor 16, then a new tubular segment (e.g., tubular, tubular stand, etc.) can be added to the tubular string 58 by retrieving a tubular segment 50, 54 from tubular storage via a pipe handler, stop mud flow and disconnect the top drive from the tubular string 58, hold the tubular string 58 in place via the slips at well center, raise the top drive 18 to provide clearance for the tubular segment to be added, transfer tubular segment 50, 54 from the pipe handler 30 to the top drive 18, connect the tubular segment 50, 54 to the top drive 18, lower the tubular segment 50, 54 to the stump of the tubular string 58 and connect it to the tubular string 58 using a roughneck to torque the connection, then start mud flow. This can be performed each time the top end of the tubular string 58 is lowered below “WW” ft above the rig floor 16.

At task 120.6, add tubular segments 50, 54 to the tubular string 58 as needed in task 120.5 to drill wellbore 15 to a depth of 150 ft. Stop rotation of the drill bit 68 and stop mud pumps 84.

At task 120.7, perform a deviation survey by reading the inclination data from the BHA 60, comparing the inclination data to expected inclination data, and report deviations from the expected. Correct drilling parameters if deviations are greater than a pre-determined limit.

The conversion from a well plan 100 to a rig-specific rig plan 102 can be performed manually or automatically with the best practices and equipment recipes known for the rig that can be used in the wellbore construction.

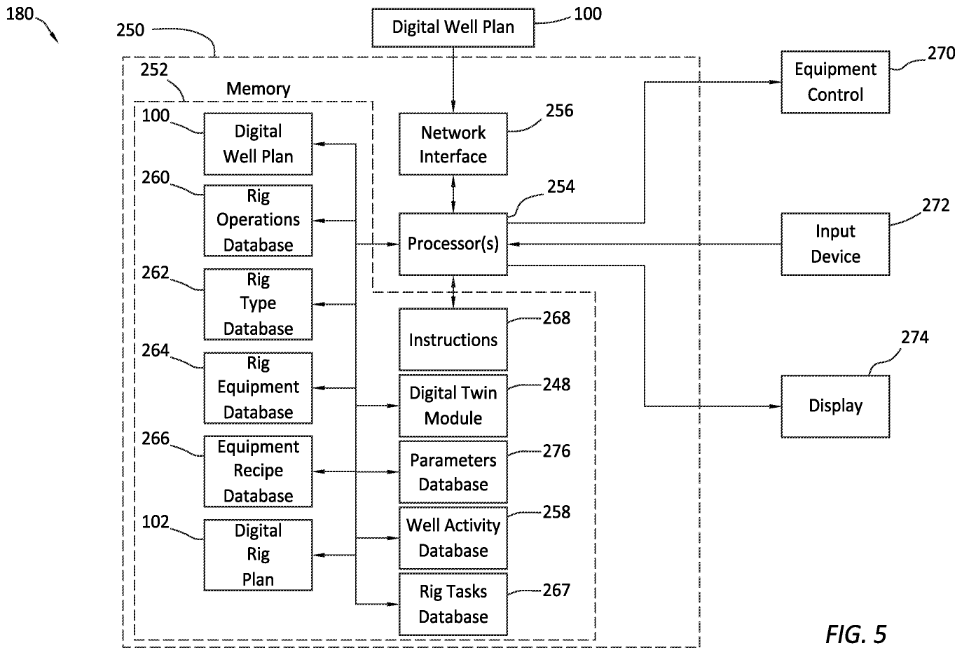

FIG. 5 is a representative functional block diagram of the rig plan conversion engine 180 that can include possible databases used by a rig controller 250 to convert a digital well plan 100 to a digital rig plan 102, for identifying individuals detected in work zones on the rig 10, storing and providing historical performance data (e.g., performance database 276). The rig plan conversion engine 180 can be a program (i.e., list of instructions 268) that can be stored in the non-transitory memory 252 and executed by processor(s) 254 of the rig controller 250 to convert a digital well plan 100 to a digital rig plan 102 or identify individuals 4 on the rig 10.

A digital well plan 100 can be received at an input to the rig controller 250 via a network interface 256. The digital well plan 100 can be received by the processor(s) 254 and stored in the memory 252. The processor(s) 254 can then begin reading the sequential list of well plan activities 170 of the digital well plan 100 from the memory 252. The processor(s) 254 can process each well plan activity 170 to create rig-specific tasks to implement the respective activity 170 on a specific rig (e.g., rig 10).

To convert each well plan activity 170 to rig-specific tasks for a rig 10, processor(s) 254 must determine the equipment available on the rig 10, the best practices, operations, and parameters for running each piece of equipment, and the operations to be run on the rig to implement each of the well plan activities 170.

Referring again to FIG. 5, the processor(s) 254 are communicatively coupled to the non-transitory memory 252 which can store multiple databases for converting the well plan 100 into the rig plan 102, for identifying individuals detected in work zones on the rig 10, and for storing performance scores. The databases identified in this disclosure may be described as being separate, but the databases can be combined in a single database or organized in multiple databases that combine some databases into one database with other databases combined into another database. For example, the parameters database 276 can be combined with the equipment recipe database 266. They are described as being separate for purposes of discussion.

A rig operations database 260 includes rig operations for implementing each of the well plan activities 170. Each of the rig operations can include one or more tasks to perform the rig operation. The processor(s) 254 can retrieve those operations for implementing the first rig activity 170 from the rig operations database 260 including the task lists for each operation. The processor(s) 254 can receive a rig type RT from a user input or the network interface 256. With the rig type RT, the processor(s) 254 can retrieve a list of equipment available on the rig 10 from the rig type database 262, which can contain equipment lists for a plurality of rig types.

The processor(s) 254 can then convert the operation tasks to rig specific tasks to implement the operations on the rig 10. The rig specific tasks can include the appropriate equipment or individuals of rig 10 to perform the operation task. The selection of equipment for each rig specific task can also be determined, at least in part, based on a historical ability of the equipment to perform the particular task.

The processor(s) 254 can then collect the recipes for operating each of the available equipment for rig 10 from the recipes database 266, where the recipes can include best practices on operating the equipment, preferred parameters for operating the equipment, and operational tasks for the equipment (such as turn ON procedures, ramp up procedures, ramp down procedures, shutdown procedures, disassembly/assembly procedures, transport procedures, etc.). When the rig specific tasks of the rig plan 102 are defined and the rig equipment is allocated to each task of the rig plan 102, the processor(s) 254 can then allocate one or more individuals 4 to each of the rig plan 102 tasks. Similar to the allocation of the rig equipment, the processor(s) 254 can select the one or more individual(s) for performing the particular task based on historical ability of the individual to perform the task. A predicted performance of the rig site 11 in executing all or at least a portion of the well plan 100 can be determined based a digital twin simulation of the rig operations based on recipes selected for controlling rig equipment and instructing individuals.

A digital well plan 100 can be developed that includes activities for a rig-down or rig-up operation, with the rig-down and rig-up operations including packing/unpacking procedures as well as transport procedures. The digital well plan 100 for rig-down and rig-up operations can be converted to a list of tasks in a rig plan 102, with the list of tasks taking into account the recipes for the equipment being moved and the equipment and resources being used to move the equipment. The digital twin simulator can model the rig plan 102 for rig-down and rig-up operations, learn codependences between resources to be utilized for the rig plan 102, and determine improvements in the rig plan 102 that can increase efficiencies in the rig-down and rig-up operations.

Therefore, the processor(s) 254 can retrieve each of the well plan activities 170 and convert them to a list of rig specific tasks that can perform the respective well plan activity 170 on the rig 10. After converting all of the well plan activities 170 to rig specific tasks 190 and creating a sequential list of the tasks 190, the processor(s) 254 can store the resulting digital rig plan 102 in the memory 252. When the rig 10 is operational and positioned at the proper location to drill a wellbore 15, the rig controller 250, via the processor(s) 254, can begin executing the list of tasks in the digital rig plan 102 by sending control signals and messages to the equipment control 270.

The rig controller 250 can also receive user input from an input device 272 or display information to a user or individual 4 via a display 274. The input device 272 in cooperation with the display 274 can be used to input well plan activities, initiate processes (such as converting the digital well plan 100 to the digital rig plan 102), select alternative activities, or rig tasks during the execution of digital well plan 100 or digital rig plan 102, or monitor operations during well plan execution. The input device 272 can also include the sensors 74 and the imaging sensors 72, which can provide sensor data (e.g., image data, temperature sensor data, pressure sensor data, operational parameter sensor data, etc.) to the rig controller 250 for determining the actual well activity of the rig.

With all equipment and individuals allocated to the digital rig plan 102 and recipes determined, then the digital twin can simulate the execution of the digital rig plan 102 based on the digital rig plan 102 parameters. By evaluating the performance of the digital rig plan 102 compared to the performance requirements of the digital well plan 100, adjustments can be made to equipment allocations, allocations of individuals, and recipes to improve the performance of the rig plan to the well plan. The digital twin can be run in real-time alongside actual operations of the rig 10 during the execution of the rig 102. This can result in adjusting parameters of the rig plan 102 further to handle dysfunctions as they arise, improve rig performance in real-time, evaluate optional tasks or activities prior to executing alternate tasks or activities.

The digital rig plan 102 can also include a list of tasks for assembly/disassembly of a rig 10 at a rig site 11, as well as moving the rig 10 from one rig site 11 to another. The digital twin can be used to simulate the assembly/disassembly of a rig 10 at a rig site 11, as well as moving the rig 10 from one location to another to help with planning the tasks to maximize efficiency, speed, etc., in moving the rig 10 to another rig site 11. The digital twin module 278 can create a 3D model of the rig 10 from 3D components (e.g., 3D models of rig equipment, individuals, support equipment, various material at rig site 11, conveyance vehicles, etc.), and operate the 3D model to perform the tasks of the rig plan 102, such as in this example of moving the rig 10 to another rig site 11. Alternatively, or in addition to, the digital twin module 278 can simulate a list of tasks of a rig plan and simulate the operations in rigging down the rig 10, transporting the rig 10 to a new rig site 11, and rigging up the rig 10 at the new rig site 11.

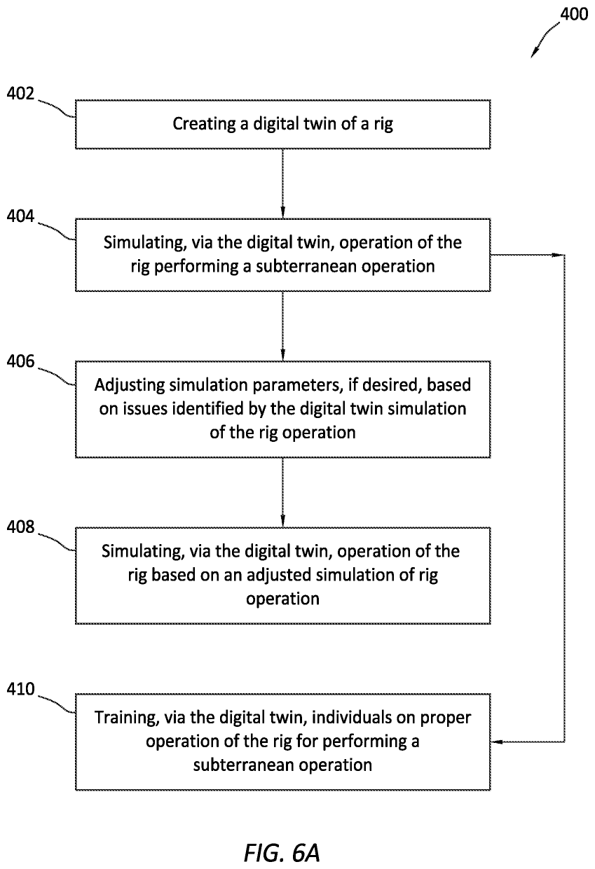

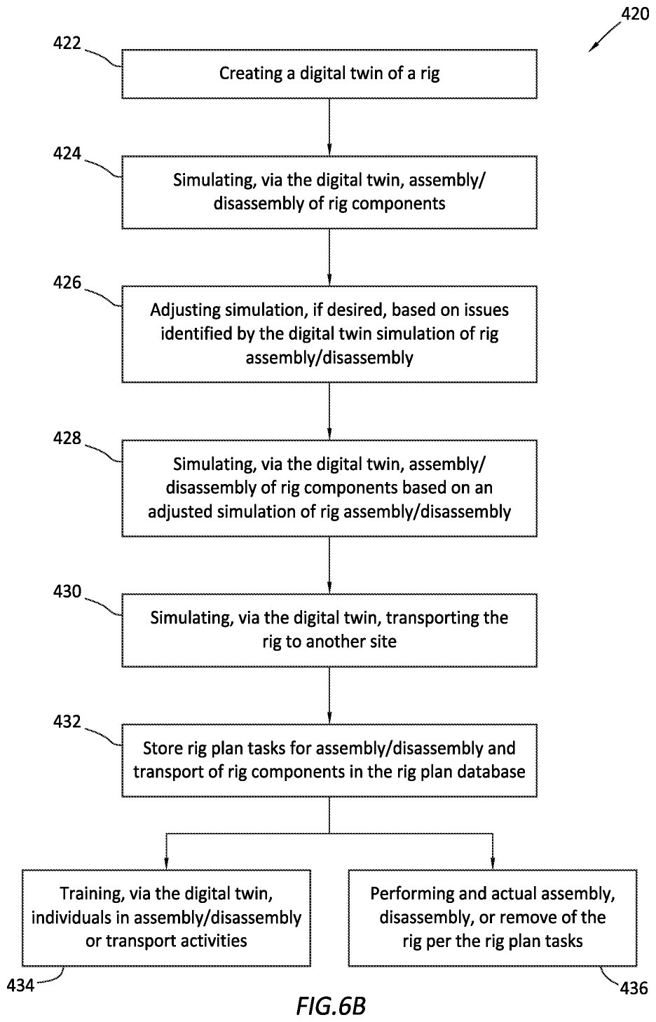

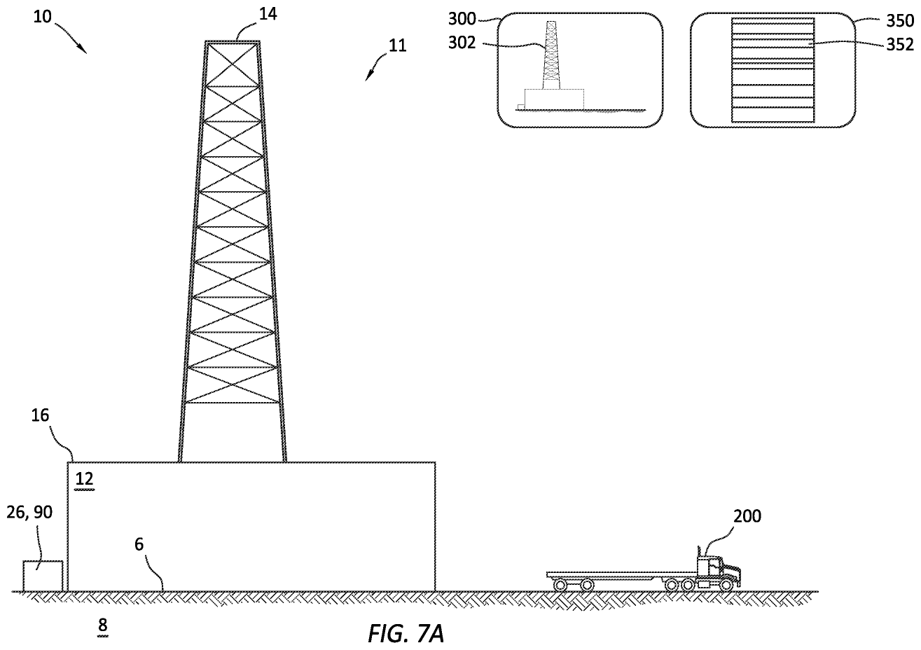

FIG. 6A is a representative functional diagram that illustrates a method 400 for simulating, via a digital twin, rig operations of a rig plan 102 for performing a subterranean operation (e.g., drilling a wellbore, completing a wellbore, etc.). The digital twin provides an opportunity for operators or designers to evaluate a performance of the rig 10 based on selected rig equipment, individuals, recipes, etc., and adjust these items to improve performance of rig 10 to the digital rig plan 102 based on a performance criterion (e.g., speed, efficiency, ROP, etc.).

In operation 402, the rig controller 250, via the digital twin module 278, can create a 3D model of the rig 10 by collecting 3D models (or retrieving specific 3D models from the 3D component database 249 shown in FIG. 3) of the selected rig equipment and individuals. The 3D models can be created by computer aided design CAD tools, captured by an imaging system 240 using LiDAR sensors, 3D cameras, or 2D cameras, or provided by a manufacturer. Alternatively, or in addition to, the digital twin module 278 can simulate a list of tasks of a rig plan and simulate the operations in rigging down the rig 10, transporting the rig 10 to a new rig site 11, and rigging up the rig 10 at the new rig site 11.

In operation 404, the digital twin module 248 can simulate the operation of the rig 10 performing a subterranean operation, based on the selected recipes for the particular pieces of rig equipment, and the selected individuals for each rig task (that is if one or more individuals are utilized for the rig task).

In operation 406, an operator, designer, or rig controller 250 can adjust parameters of the digital twin if performance issues are detected during the simulation. The parameters can include the rig equipment, individuals, and recipes. These parameters can be adjusted as desired to improve performance (or reduce performance).

In operation 408, the digital twin module 248 can simulate the operation of the rig 10 performing a subterranean operation, based on the adjusted recipes, adjusted allocations of individuals, or adjusted allocations of rig equipment. The performance of the rig 10 to execute the digital rig plan 102 can be further evaluated and additional parameter adjustments can be made if desired. Operations 406 and 408 can be repeated as needed to determine the individuals, rig equipment, and recipes that provide the best performance of the digital rig plan 102.

In operation 410, the digital twin can be used to train individuals 4 on the proper operation of the rig 10 and its equipment to perform tasks in a digital rig plan 102. The digital twin can demonstrate proper operation of rig equipment or individuals to illustrate the desired method of controlling and executing the rig tasks in the rig plan 102. However, the digital twin can also be used to demonstrate the improper operation of rig equipment or individuals to illustrate the consequences of poorly controlling and executing the rig tasks in the rig plan 102, which can at least reinforce the need to perform the tasks as desired.

FIG. 6B is a representative functional diagram that illustrates a method 420 for simulating, via a digital twin, rig operations of a rig plan 102 for disassembling a rig 10 at one rig site 11, moving the rig 10 to another rig site 11, and assembling the rig 10 at the new rig site 11. The digital twin provides an opportunity for operators or designers to evaluate a performance of a rig plan 102 for moving the rig 10 to a new rig site 11 based on a performance criterion (speed, efficiency, risk, etc.). For example, if speed is the higher priority criteria, then the digital twin can adjust the rig plan to optimize speed and reduce delays in the operation. For example, if efficiency is the higher priority criteria, then the digital twin can adjust the rig plan to optimize efficiency, which in some cases may cause delays in the operation to maintain efficiency. For example, if the risk is the higher priority criteria, then the digital twin can adjust the rig plan to minimize risks in performing the operation. The operation can be disassembly, moving, or assembly of the rig 10, or combinations thereof.

The performance criteria can be verified by performing an actual assembly of the rig at the rig site; monitoring an actual performance criteria during the actual assembly; comparing the actual performance criteria to a simulated performance criteria of the digital twin; and identifying differences between the actual performance criteria and the simulated performance criteria. The rig plan can then be adjusted to minimize the differences (e.g., errors) between the actual and simulated versions of the rig plan.

In operation 422, the rig controller 250, via the digital twin module 278, can create a 3D model of the rig 10 by collecting 3D models (or retrieving specific 3D models from the 3D component database 249 shown in FIG. 3) of selected rig equipment, as well as support equipment and individuals for moving the rig equipment of rig 10. The 3D models can be created by computer aided design CAD tools, captured by an imaging system 240 using LiDAR sensors, 3D cameras, or 2D cameras, or provided by a manufacturer. Alternatively, or in addition to, the digital twin module 278 can simulate a list of tasks of a rig plan and simulate the operations in rigging down the rig 10, transporting the rig 10 to a new rig site 11, and rigging up the rig 10 at the new rig site 11.

In operation 424, digital twin module 248 can simulate assembly or disassembly of rig components of a rig 10 at a rig site 11. The rig components can include rig structures (e.g., derrick 14, platform 12, horizontal storage 56, vertical storage 36, etc.), support equipment (e.g., crane 46, power system 26, material handlers, tubulars 54, material 76, mud, pumps 84, fluid treatment 82, shaker 80, wellhead, slips 92, drawworks 13, traveling block 19, top drive 18, fluid tubing 86, BHA, downhole tools, iron roughneck 38, mud bucket, catwalk 20, forklifts 48, etc.), personnel offices/rooms (e.g., living quarters, control hut, etc.), personnel, and conveyance vehicles.

In operation 426, during simulation of assembly or disassembly of the rig components of a rig 10 at a rig site 11, the operator, rig controller 250, designer, or other user can identify issues with the assembly or disassembly (e.g., sequences for unloading/loading conveyance vehicles of rig components, organization of packing/unpacking the conveyance vehicles with the rig components, individuals needed at each stage of assembly or disassembly of the rig components, potential equipment failures, the fuel consumption of conveyance vehicles, etc.). When issues are identified, parameters of the simulation can be adjusted to manage or mitigate the identified issues by changing the assembly or disassembly tasks (e.g., change sequences for unloading/loading conveyance vehicles, change the organization of packing/unpacking the conveyance vehicles with the rig components, change the allocation of individuals to improve efficiencies of performing the tasks, address potential equipment failures, modify usage of conveyance vehicles to improve fuel consumption, etc.). For example, the simulation can be used to evaluate alternative rig plan tasks if an unplanned event occurs, and the rig plan cannot be executed as planned. When the most efficient set of alternative rig plan tasks are identified, the rig plan can be modified to include the alternative rig plan tasks.

Issues with the assembly or disassembly (or move) of the rig 10 can include identifying an efficiency of a sequence of the digital twin that is below a desired level and adjusting the tasks of the rig plan 102 to improve the efficiency to a level that is above a desired level. The efficiency can include an order of unpacking the rig components from the one or more conveyance vehicles; a number of the conveyance vehicles that transported the rig components; a type of conveyance vehicle that transported the rig components; an assembly sequence of segments of one or more of the rig components; an assembly sequence of the rig components; a number of individuals supporting the unpacking; an identity of each of the individuals supporting the unpacking; and a combination thereof.

For disassembly, the efficiency of the sequence can include an order of packing the rig components to be transported by the one or more conveyance vehicles; a number of the conveyance vehicles for transporting the rig components; a type of conveyance vehicle for transporting the rig components; a disassembly sequence of the rig components; a disassembly sequence of segments of one or more of the rig components; a number of individuals supporting the packing; an identity of each of the individuals supporting the packing; and a combination thereof.

In operation 428, the simulation can be used to determine impacts of changing the assembly or disassembly tasks. The parameters of assembling or disassembling the rig components can be adjusted to optimize the rig tasks for assembling or disassembling the rig components.

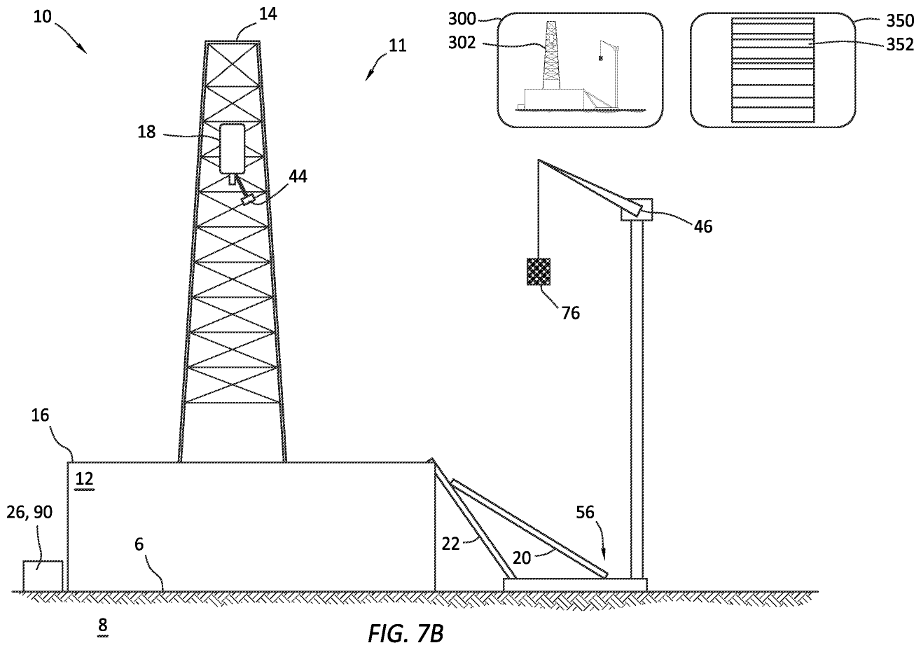

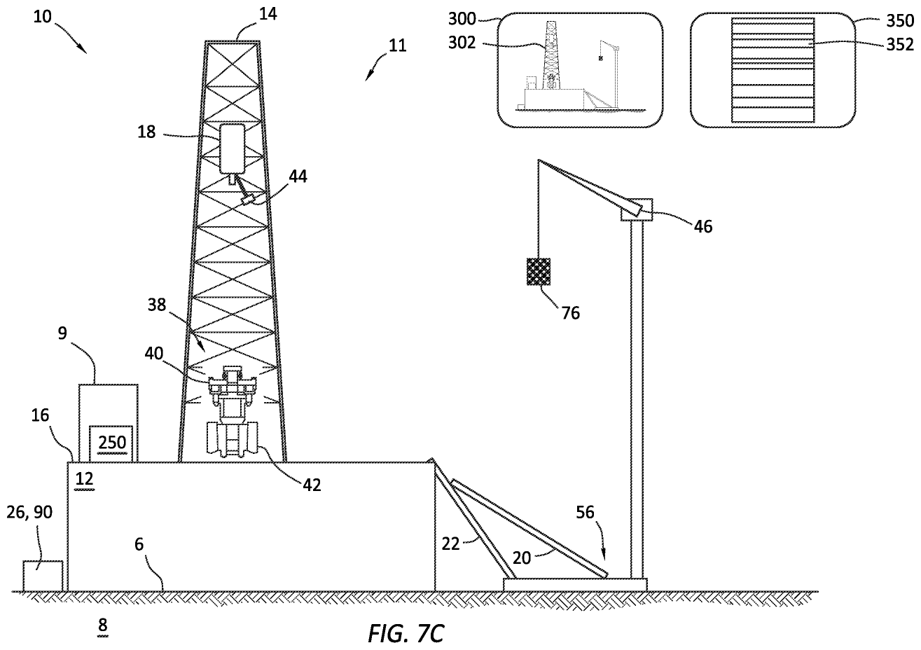

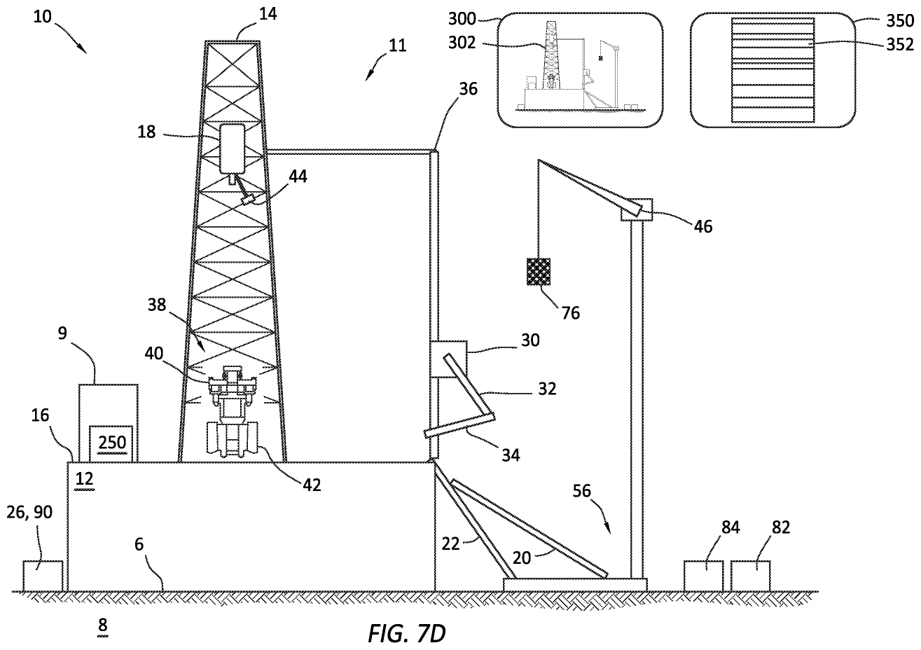

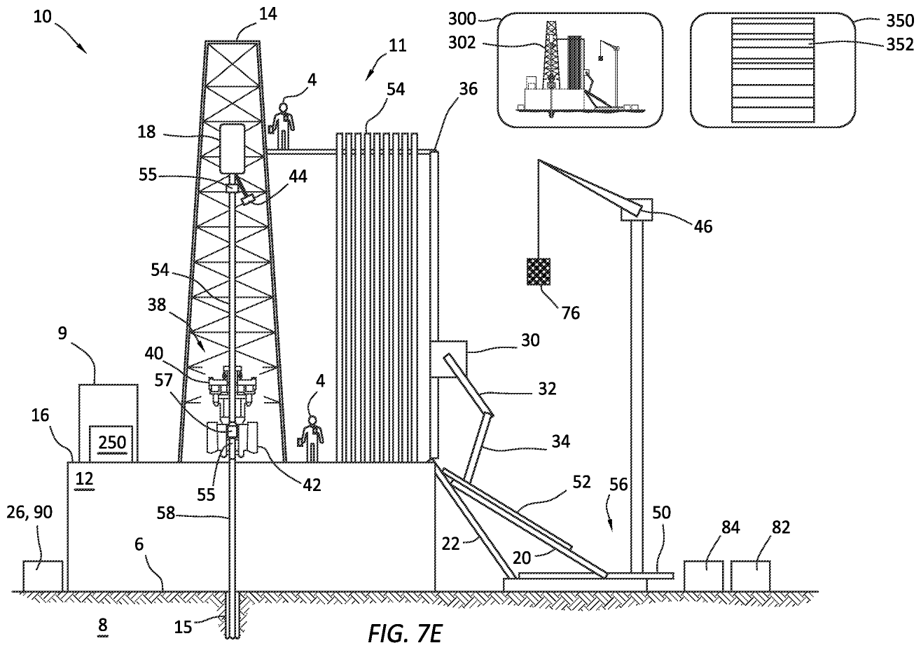

In operation 430, digital twin module 248 can simulate transporting the rig components of a rig 10 to a new rig site 11. The simulation of transporting the rig components can be based on the assembly or disassembly tasks, such as packing/unpacking or organization of the rig components on the conveyance vehicles (such as conveyance vehicle 200 in FIG. 7A). Therefore, the simulation of transporting the rig components can simulate using the number of conveyance vehicles 200 (can also be referred to as trucks) determined by the assembly or disassembly simulations. Adjusting the assembly or disassembly simulation parameters can also affect the performance of the simulation of transporting the rig components. For example, fuel consumption for the conveyance vehicles can be reduced if fewer conveyance vehicles 200 are used to transport the rig components.

Operations 426 thru 430 can be repeated as needed to determine the optimum rig plan tasks, including parameters, for moving the rig 10 from one rig site 11 to another rig site 11.

In operation 432, when the operator, rig controller 250, designer, or other user determines that the desired efficiencies of assembly or disassembly of the rig components and transporting the rig components are reached based on the simulations, the resulting rig plan tasks can be stored in a rig plan database 102 and used in the future to coordinate moving the rig components of a rig 10 to a new rig site 11.

In operation 434, the rig tasks can be retrieved from the rig plan database 102 and simulated via the digital twin module 278 to train individuals 4 on the processes and procedures for moving a rig 10 to a new rig site. Each rig task can be analyzed by the trainee 4 to understand the desired operation of the rig tasks by the rig equipment, support equipment, or individuals. The individual 4 can be trained on performing at least a portion of the assembly (can also apply to disassembly or moving the rig) of the rig at the rig site.

To verify the training, the individual can perform, the portion of the assembly of the rig and a performance of the individual can be compared to an expected performance level. Depending on the actual performance level of the individual, the training can be adjusted to improve the performance of the individual to a desired performance level; the training can continue to improve the performance of the individual to a desired performance level; or the training can be stopped (or temporarily halted) if the performance level of the individual is at or above the expected performance level.

In operation 436, the rig 10 can be moved according to the rig plan 102 by using the rig plan 102 to coordinate disassembling, transporting, and assembling rig components as the rig 10 is being moved from one rig site 11 to another rig site 11. Real-time data can be collected and sent to the rig controller 250, which can update the digital twin based on the real-time data and improve the accuracy of the digital twin simulation.

The digital twin can simulate transporting (or moving) the rig 10 to a new site 11, and the simulation of the move can include simulating one of a speed of each of the one or more conveyances while transporting the rig components; a weight of each of the one or more conveyances while transporting the rig components; a 3D representation of terrain elevation changes along a route between the rig site and the new rig site; environmental conditions along the route; travel restrictions along the route; surface conditions along the route; a risk factor, wherein the risk factor indicates a risk of transporting the rig to the new rig site along the route; or combinations thereof.

The digital twin can also be used to predict usage of equipment, individuals 4, conveyance vehicles 200, as well as fuel consumption. The digital twin can predict an estimated fuel consumption for one or more conveyance vehicles 200. When the rig 10 is actually moved to a new rig site 11, the fuel consumption can be monitored to determine an actual fuel consumption for the move, and the actual fuel consumption can be compared to the estimated fuel consumption to determine differences. The digital twin can be adjusted to compensate for the differences so future moves can be estimated with improved accuracy.

FIGS. 7A-7E are representative simplified front views of a rig 10 in various stages of assembly (or disassembly) at a rig site 11 with a corresponding display generated by a digital twin which is running a simulation of the assembly (or disassembly) of the rig 10. The following discussion is related to FIGS. 7A-7E is generally directed toward assembly activities or tasks for assembling the rig 10 at the rig site 11. However, it should be understood that the discussion can also relate to disassembly activities except that these activities or tasks may be performed in reverse order to the assembly activities or tasks. There the assembly can be seen as FIGS. 7A-7E, where the disassembly can be seen as FIGS. 7E-7A. It should also be understood that the example rig 10 in FIGS. 7A-7E is merely a rig for discussion purposes. The current digital twin simulation and assembly/disassembly processes can be utilized for all types of rigs.

FIG. 7A shows a conveyance vehicle 200 that can be used to transport rig components when they are moved to a new rig site 11. It should be understood, this conveyance vehicle 200 can be any vehicle that is used to transport any one of the rig components, such as trucks, tractor trailer rigs, custom vehicles, aircraft, vans, walking platforms, etc. In FIG. 7A, the rig components that make up the rig platform 12, the derrick 14, and the power system 26 have been delivered to the rig site 11 and the rig plan tasks that direct the assembly of these items have been executed. The derrick 14 can be a single tower that is transported by one tractor trailer rig or can include multiple segments, requiring two or more conveyance vehicles 200 to transport the derrick 14 to the new rig site 11. The platform 12 can also be moved as one unit, such as with walking platforms, or if the platform is small enough, it can be moved by a single tractor trailer rig. The platform 12 can also be made up of multiple segments, requiring two or more conveyance vehicles 200 to transport the platform 12 to the new rig site 11. Similarly, the remaining components of the rig 10 can be one or multiple segments, and the rig plan 102 can be used to plan the sequence of events for assembling or disassembling the rig and transporting the rig components (including all segments) to a new rig site 11. For example, the power system 26 can be a single generator pulled behind a single tractor trailer rig or can be several generators requiring multiple conveyance vehicles 200.

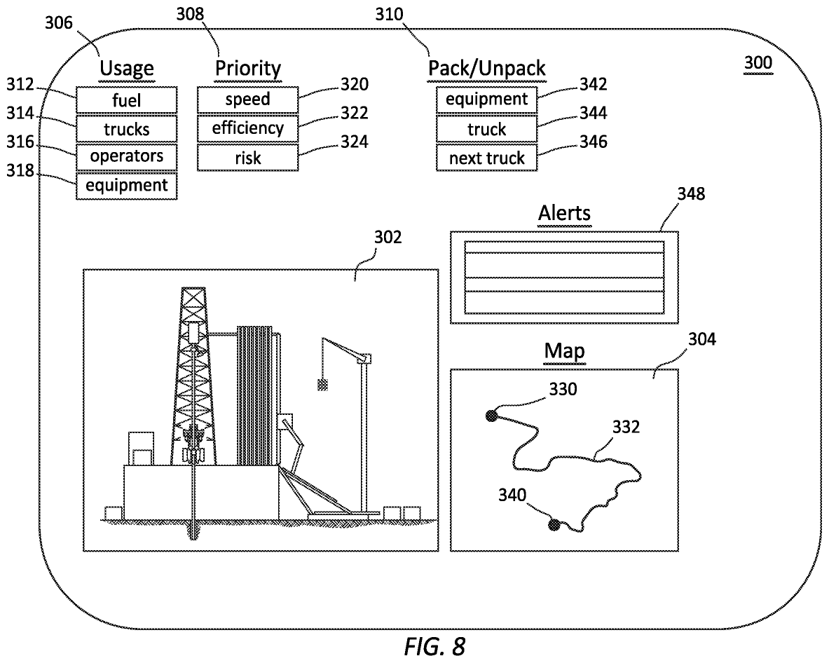

The digital twin can be used to simulate the assembly tasks in the rig plan 102. In each of the FIGS. 7A-7E, a human machine interface (HMI) 300 or 350 is represented that can provide visualization to the operators, designers, or other users 4 by displaying images 302, 352 of the digital twin as the simulation is executed. The HMI 300 can also provide visualization of other pertinent information on the HMI 300, for example as shown in FIG. 8. However, as in FIG. 7A, the image 302 on the HMI 300 shows the digital twin at a similar state of progress in the assembly of the rig 10. This illustrates that an operator, designer, or another user 4 can both monitor the progress of the actual assembly of the rig 10 with the simulated version of the rig assembly of the digital twin, as well as use the digital twin to guide the assembly process.

The HMI 300 can display the progress of a digital twin 3D model simulation showing specific component visualization of the 3D model and animating the simulation for visualization of the process. Alternatively, or in addition, the HMI 350 can display the progress of the digital twin simulation as shown by updating the lists of tasks and visually displaying the lists via an image 352 on the HMI 350 while updating in real-time (referenced to the simulation or possibly actual operations) the progress of the listed tasks. The adherence, or lack thereof, of the simulation to the desired constraints of the rig move can be used to improve actual tasks. The digital twin simulation can also be used to mitigate unplanned events, such as equipment failure, resource availability, etc., by simulating alternative paths to mitigate the event and return the operations back to the rig plan 102.

FIG. 7B shows that additional rig equipment and rig structures have been added to the rig 10 as the assembly process progresses. The crane 46 has been installed for moving material 76 around the rig site 11. The catwalk 20, V-door ramp 22, and horizontal storage area 56 have been assembled at the rig site 11. These rig components can be used to store and manipulate tubulars 50. The top drive 18 with an elevator 44 has also been installed on the platform 12 and coupled to the derrick 14. As the image 302 on the HMI 300 indicates, or image 352 on the HMI 350, the digital twin can be tracking the assembly progress of the rig components at the rig site 11 or the digital twin can be guiding the assembly process and the assembly process has caught up to the simulation.

It should be understood that the digital twin can also be used to evaluate deviations from the rig plan 102 prior to the deviations from the plan occurring. This allows the operator, designer, or other user 4 to make better decisions about tasks for mitigating a deviation from the rig plan 102 or even optimize rig tasks to be inserted into the digital rig plan 102 to manage the deviation.

In FIG. 7C, the control hut 9 and the iron roughneck 38 have been installed on the rig floor 16 of the platform 12 as the assembly continues. As the image 302 on the HMI 300, or image 352 on the HMI 350, indicates, the digital twin can be tracking the assembly progress of the rig components at the rig site 11 or the digital twin can be guiding the assembly process and the assembly process has caught up to the simulation.

In FIG. 7D, the pipe handler 30, pumps 84, and fluid treatment 82 have been installed at the rig site 11 as the assembly continues. As the image 302 on the HMI 300, or image 352 on the HMI 350, indicates, the digital twin can be tracking the assembly progress of the rig components at the rig site 11 or the digital twin can be guiding the assembly process and the assembly process has caught up to the simulation. At this stage, the rig 10 assembly is complete and ready to begin performing a subterranean operation.

In FIG. 7E, the rig may be in the process of drilling a wellbore 15, with tubulars and other necessary material supplied to support the subterranean operation, such as drilling. As the image 302 on the HMI 300, or image 352 on the HMI 350, indicates, the digital twin can be tracking the progress of the subterranean operation, or the digital twin can be guiding the subterranean operation. In this configuration, the assembly process is complete, and the digital twin can be used to simulate the rig plan 102 for performing a subterranean operation, such as drilling.

FIG. 8 is a representative view of an HMI 300 that can be used to interact with an individual while providing visualization of various parameters and images from the digital twin. The HMI 300 can include an image 302 that displays the state of the execution of the digital twin. This can be generated by the digital twin module 248 in the rig controller 250 based on 3D model of the rig 10 (or rig site 11). The image 302 indicates that the digital twin is simulating the rig 10 performing a subterranean operation.

The digital twin can prioritize different operational parameters based on a priority 308, such as speed 320, efficiency 322, or risk 324, as well as others not shown here, such as minimizing overtime for personnel, minimizing the usage of resources, such as fuel consumption, number of trucks, number of operators/individuals 4. The digital twin can report or display to the operator, designer, or other user 4 the usage 306 of resources, such as fuel consumption 312, number of trucks (or conveyance vehicles 200), number of operators 316, and usage of other equipment 318 (such as power systems 26). The HMI 300 can also display Pack/Unpack items 310 of the assembly/disassembly simulation, such as what equipment 342 is being loaded/unloaded, which conveyance vehicle 200 is being loaded/unloaded, and the next conveyance vehicle 200 to be loaded/unloaded. Since the digital twin can also simulate the transportation of the rig components via conveyance vehicles 200, the digital twin can display the projected route 332 between the current rig site 330 and the destination rig site 340 via the visual map 304. The digital twin can simulate the transporting of the rig components by the conveyance vehicles 200 along the route 332 over a 3D terrain model to analyze fuel consumption, vehicle wear/usage, traffic regulations and laws, terrain constraints, etc.

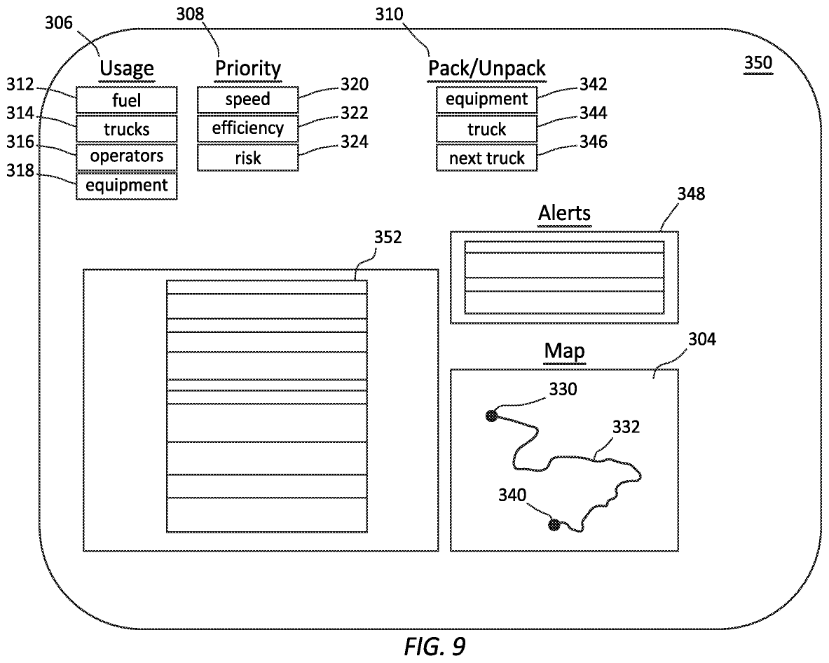

FIG. 9 is a representative view of an HMI 350 that can be used to interact with an individual while providing visualization of various parameters and images from the digital twin. The HMI 350 can include an image 302 that displays the state of the execution of the tasks in the digital twin simulation. This can be generated by the digital twin module 248 in the rig controller 250 based on the rig plan 102. The image 352 indicates the progress of the digital twin when simulating the rig 10 operations. The remaining items on the HMI 350 are described above with reference to FIG. 8.

### Various Embodiments

Embodiment 1. A method for simulating a rig operation comprising:
creating a digital twin of a rig based on a rig plan for assembling a rig;
simulating, via the digital twin, the rig plan, wherein the rig plan comprises a list of tasks for assembly of rig components to assemble the rig; and
simulating, via the digital twin, assembly of the rig components at a rig site.

Embodiment 2. The method of embodiment 1, further comprising:
creating the digital twin of the rig based on a 3D model of the rig, wherein the 3D model comprises 3D models of the rig components of the rig.

Embodiment 3. The method of embodiment 1, wherein the list of tasks includes operations performed by rig equipment, one or more individuals, or combinations thereof to assemble the rig at a rig site.

Embodiment 4. The method of embodiment 3, further comprising:
performing an actual assembly of the rig at the rig site;
comparing the actual assembly of the rig to a simulated assembly of the digital twin;
identifying differences between the actual assembly and the simulated assembly; and.
modifying the rig plan based on the differences.

Embodiment 5. The method of embodiment 4, wherein the difference is an unplanned event, and wherein the modifying the rig plan comprises simulating, via the digital twin, alternative rig plan tasks to manage the unplanned event, and modifying the rig plan to include the alternative rig plan tasks.

Embodiment 6. The method of embodiment 1, further comprising:
simulating, via the digital twin, unpacking one or more of the rig components from one or more conveyance vehicles according to a sequence, wherein the sequence is based on the rig plan.

Embodiment 7. The method of embodiment 6, further comprising:
identifying an efficiency of the sequence; and
adjusting the rig plan to improve the efficiency of the sequence.

Embodiment 8. The method of embodiment 7, wherein the efficiency of the sequence comprises one of:
an order of unpacking the rig components from the one or more conveyance vehicles;
a number of the conveyance vehicles that transported the rig components;
a type of conveyance vehicle that transported the rig components;
an assembly sequence of segments of one or more of the rig components;
an assembly sequence of the rig components;
a number of individuals supporting the unpacking;
an identity of each of the individuals supporting the unpacking; and
a combination thereof.

Embodiment 9. The method of embodiment 1, further comprising:
adjusting the rig plan, based on the digital twin, thereby determining primary activities, secondary operations, or combinations thereof of the rig plan that can be performed simultaneously during assembly of the rig.

Embodiment 10. The method of embodiment 1, further comprising:
adjusting the rig plan, based on the digital twin, thereby optimizing a performance criterion, wherein the performance criteria comprises speed, efficiency, risk, or combinations thereof.

Embodiment 11. The method of embodiment 10, further comprising:
performing an actual assembly of the rig at the rig site;
monitoring an actual performance criteria during the actual assembly;
comparing the actual performance criteria to a simulated performance criterion of the digital twin; and
identifying differences between the actual performance criteria and the simulated performance criteria.

Embodiment 12. The method of embodiment 11, further comprising:
modifying the digital twin, based on the differences, to reduce errors between the actual performance criteria and the simulated performance criteria.

Embodiment 13. The method of embodiment 1, further comprising:
determining, via the digital twin, locations of the rig components at the rig site.

Embodiment 14. The method of embodiment 13, further comprising:
installing the rig components at the rig site at the locations determined by the digital twin.

Embodiment 15. The method of embodiment 1, further comprising:
determining zones of the rig, wherein each zone comprises one or more of the rig components.

Embodiment 16. The method of embodiment 15, wherein the one or more of the rig components are associated with one or more functions of the rig.

Embodiment 17. The method of embodiment 16, further comprising:
determining, via the digital twin, locations of the rig components at the rig site based on the zones.

Embodiment 18. The method of embodiment 1, further comprising:
adjusting the rig plan, based on the digital twin, to optimize a performance criterion, wherein the performance criteria comprises speed, efficiency, risk, or combinations thereof; and
approving, via an individual or rig controller, an approved version of the rig plan after one or more simulations of the assembly of the rig via the digital twin.

Embodiment 19. The method of embodiment 18, further comprising:
assembling the rig components at the rig site based on the approved version of the rig plan.

Embodiment 20. The method of embodiment 1, further comprising:
training, via the digital twin, an individual to perform at least a portion of the assembly of the rig at the rig site.

Embodiment 21. The method of embodiment 20, further comprising:
performing, via the individual, the portion of the assembly of the rig; and
comparing a performance of the individual to an expected performance level of the individual.

Embodiment 22. The method of embodiment 21, further comprising one of:
adjusting the training of the individual to improve the performance of the individual to a performance level at or above the expected performance level;
continuing the training of the individual to improve the performance of the individual to a performance level at or above the expected performance level; and
stopping the training if the performance level of the individual is at or above the expected performance level.

Embodiment 23. A method for simulating a rig operation comprising:
creating a digital twin of a rig based on a rig plan for disassembling a rig;
simulating, via the digital twin, the rig plan, wherein the rig plan comprises a list of tasks for assembly of rig components to assemble the rig; and
simulating, via the digital twin, disassembly of the rig components at a rig site.

Embodiment 24. The method of embodiment 23, further comprising:
training, via the digital twin, an individual to perform at least a portion of a disassembly of the rig at the rig site.

Embodiment 25. The method of embodiment 24, further comprising:
performing, via the individual, the portion of the disassembly of the rig; and
comparing a performance of the individual to an expected performance level of the individual.

Embodiment 26. The method of embodiment 25, further comprising one of:
adjusting the training of the individual to improve a performance of the individual to a performance level at or above the expected performance level;
continuing the training of the individual to improve the performance of the individual to a performance level at or above the expected performance level; and
stopping the training if the performance level of the individual is at or above the expected performance level.

Embodiment 27. The method of embodiment 23, further comprising:
creating the digital twin of the rig based on a 3D model of the rig, wherein the 3D model comprises 3D models of the rig components of the rig.

Embodiment 28. The method of embodiment 23, wherein the list of tasks includes operations performed by rig equipment, one or more individuals, or combinations thereof to disassemble the rig at a rig site.

Embodiment 29. The method of embodiment 28, further comprising:
performing an actual disassembly of the rig at the rig site;
comparing the actual disassembly of the rig to a simulated disassembly of the digital twin;
identifying differences between the actual disassembly and the simulated disassembly; and
modifying the rig plan based on the differences.

Embodiment 30. The method of embodiment 29, wherein the difference is an unplanned event, and wherein the modifying the rig plan comprises simulating, via the digital twin, alternative rig plan tasks to manage the unplanned event, and modifying the rig plan to include the alternative rig plan tasks.

Embodiment 31. The method of embodiment 1, further comprising:
determining zones of the rig, wherein each zone comprises one or more of the rig components.

Embodiment 32. The method of embodiment 31, wherein the one or more of the rig components are associated with one or more functions of the rig.

Embodiment 33. The method of embodiment 32, further comprising:
determining, via the digital twin, disassembly of the rig based on the zones of the rig.

Embodiment 34. The method of embodiment 23, further comprising:
adjusting the rig plan, based on the digital twin, thereby determining primary activities, secondary operations, or combinations thereof of the rig plan that can be performed simultaneously during disassembly of the rig.

Embodiment 35. The method of embodiment 23, further comprising:
adjusting the rig plan, based on the digital twin, to optimize a performance criterion, wherein the performance criteria comprises speed, efficiency, risk, or combinations thereof.

Embodiment 36. The method of embodiment 35, further comprising:
approving, via an individual or rig controller, an approved version of the rig plan after one or more simulations of the disassembly of the rig via the digital twin.

Embodiment 37. The method of embodiment 36, further comprising:
assembling the rig components at the rig site based on the approved version of the rig plan.

Embodiment 38. The method of embodiment 35, further comprising:
performing an actual disassembly of the rig at the rig site;
monitoring an actual performance criteria during the actual disassembly;
comparing the actual performance criteria to a simulated performance criterion of the digital twin; and
identifying differences between the actual performance criteria and the simulated performance criteria.

Embodiment 39. The method of embodiment 38, further comprising:
modifying the digital twin, based on the differences, to reduce errors between the actual performance criteria and the simulated performance criteria.

Embodiment 40. The method of embodiment 23, further comprising:
simulating, via the digital twin, configuring of one or more of the rig components to be transported by one or more conveyance vehicles according to a sequence, wherein the sequence is based on the rig plan.

Embodiment 41. The method of embodiment 40, further comprising:
identifying an efficiency of the sequence; and
adjusting the rig plan to improve the efficiency of the sequence.

Embodiment 42. The method of embodiment 41, wherein the efficiency of the sequence comprises one of:
an order of packing the rig components to be transported by the one or more conveyance vehicles;
a number of the conveyance vehicles for transporting the rig components;
a type of conveyance vehicle for transporting the rig components;
a disassembly sequence of the rig components;
a disassembly sequence of segments of one or more of the rig components;
a number of individuals supporting the packing;
an identity of each of the individuals supporting the packing; and
a combination thereof.

Embodiment 43. The method of embodiment 40, further comprising:
simulating, via the digital twin, transporting the rig components for the rig site to a new rig site via the one or more conveyance vehicles.

Embodiment 44. The method of embodiment 43, wherein the digital twin further comprises simulating one of:
a speed of each of the one or more conveyances while transporting the rig components;
a weight of each of the one or more conveyances while transporting the rig components;
a 3D representation of terrain elevation changes along a route between the rig site and the new rig site;
environmental conditions along the route;
travel restrictions along the route;
surface conditions along the route;
a risk factor, wherein the risk factor indicates a risk of transporting the rig to the new rig site along the route; and
combinations thereof.

Embodiment 45. The method of embodiment 43, further comprising:
predicting an estimated fuel consumption for each one of the one or more conveyance vehicles.

Embodiment 46. The method of embodiment 43, further comprising:
predicting an estimated fuel consumption of the one or more conveyance vehicles.

Embodiment 47. The method according to any one of embodiments 45 to 46, further comprising:
transporting the rig components to the new rig site according to the rig plan; and
comparing an actual fuel consumption to the estimated fuel consumption.

Embodiment 48. The method of embodiment 47, further comprising:
adjusting the rig plan based on differences between the estimated fuel consumption and the actual fuel consumption.

Embodiment 49. The method of embodiment 48, further comprising:
transporting the rig from the new rig site to another rig site based on the adjusted rig plan.

Embodiment 50. After performing any one of the methods of embodiments 23 through 49, performing any one of the methods of embodiments 1 through 22.

Embodiment 51. A method for simulating and performing a rig operation comprising:
creating a digital twin of a rig based on a rig plan for the rig;
simulating, via the digital twin, the rig plan, wherein the rig plan comprises a list of tasks for moving rig components of the rig; and
simulating, via the digital twin, moving the rig components from a first location to a second location.

Embodiment 52. The method of embodiment 51, further comprising:
simulating, via the digital twin, configuring of one or more of the rig components to be transported by one or more conveyance vehicles according to a sequence, wherein the sequence is based on the rig plan.

Embodiment 53. The method of embodiment 52, further comprising:
identifying an efficiency of the sequence; and
adjusting the rig plan to improve the efficiency of the sequence.

Embodiment 54. The method of embodiment 53, wherein the efficiency of the sequence comprises one of:
an order of packing the rig components to be transported by the one or more conveyance vehicles;
a number of the conveyance vehicles for transporting the rig components;
a type of conveyance vehicle for transporting the rig components;
a disassembly sequence of the rig components;
a disassembly sequence of segments of one or more of the rig components;
a number of individuals supporting the packing;
an identity of each of the individuals supporting the packing; and
a combination thereof.

Embodiment 55. The method of embodiment 52, further comprising:
simulating, via the digital twin, transporting the rig components for the rig site to a new rig site via the one or more conveyance vehicles.

Embodiment 56. The method of embodiment 55, wherein the digital twin further comprises simulating one of:
a speed of each of the one or more conveyances while transporting the rig components;
a weight of each of the one or more conveyances while transporting the rig components;
a 3D representation of terrain elevation changes along a route between the rig site and the new rig site;
environmental conditions along the route;
travel restrictions along the route;
surface conditions along the route;
a risk factor, wherein the risk factor indicates a risk of transporting the rig to the new rig site along the route; and
combinations thereof.

Embodiment 57. The method of embodiment 55, further comprising:
predicting an estimated fuel consumption for each one of the one or more conveyance vehicles.

Embodiment 58. The method of embodiment 55, further comprising:
predicting an estimated fuel consumption of the one or more conveyance vehicles.

Embodiment 59. The method according to any one of embodiments 57 to 58, further comprising:
transporting the rig components to the new rig site according to the rig plan; and
comparing an actual fuel consumption to the estimated fuel consumption.

Embodiment 60. The method of embodiment 59, further comprising:
adjusting the rig plan based on differences between the estimated fuel consumption and the actual fuel consumption.

Embodiment 61. The method of embodiment 60, further comprising:
transporting the rig from the new rig site to another rig site based on the adjusted rig plan.

Embodiment 62. A computer system configured to perform any of the methods of embodiments 1 through 61.

While the present disclosure may be susceptible to various modifications and alternative forms, specific embodiments have been shown by way of example in the drawings and tables and have been described in detail herein. However, it should be understood that the embodiments are not intended to be limited to the particular forms disclosed. Rather, the disclosure is to cover all modifications, equivalents, and alternatives falling within the spirit and scope of the disclosure as defined by the following appended claims. Further, although individual embodiments are discussed herein, the disclosure is intended to cover all combinations of these embodiments.

1. A method for simulating a rig operation comprising:
creating a digital twin of a rig based on a rig plan for disassembling a rig;
simulating, via the digital twin, the rig plan, wherein the rig plan comprises a list of tasks for disassembly of rig components to disassemble the rig; and
simulating, via the digital twin, disassembly of the rig components at a rig site.

2. The method of claim 1, further comprising:
training, via the digital twin, an individual to perform at least a portion of a disassembly of the rig at the rig site.

3. The method of claim 2, further comprising:
performing, via the individual, the portion of the disassembly of the rig; and
comparing a performance of the individual to an expected performance level of the individual.

4. The method of claim 3, further comprising one of:
adjusting the training of the individual to improve a performance of the individual to a performance level at or above the expected performance level;
continuing the training of the individual to improve the performance of the individual to a performance level at or above the expected performance level; and
stopping the training if the performance level of the individual is at or above the expected performance level.

5. The method of claim 1, further comprising:
creating the digital twin of the rig based on a 3D model of the rig, wherein the 3D model comprises 3D models of the rig components of the rig.

6. The method of claim 1, wherein the list of tasks includes operations performed by rig equipment, one or more individuals, or combinations thereof to disassemble the rig at a rig site.

7. The method of claim 6, further comprising:
performing an actual disassembly of the rig at the rig site;
comparing the actual disassembly of the rig to a simulated disassembly of the digital twin;
identifying a difference between the actual disassembly and the simulated disassembly; and
modifying the rig plan based on the difference.

8. The method of claim 7, wherein the difference is an unplanned event, and wherein the modifying the rig plan comprises simulating, via the digital twin, alternative rig plan tasks to manage the unplanned event, and modifying the rig plan to include the alternative rig plan tasks.

9. The method of claim 1, further comprising:
determining zones of the rig, wherein each zone comprises one or more of the rig components.

10. The method of claim 9, wherein the one or more of the rig components are associated with one or more functions of the rig.

11. The method of claim 10, further comprising:
determining, via the digital twin, disassembly of the rig based on the zones of the rig.

12. The method of claim 1, further comprising:
adjusting the rig plan, based on the digital twin, thereby determining primary activities, secondary operations, or combinations thereof of the rig plan that can be performed simultaneously during disassembly of the rig.

13. The method of claim 1, further comprising:
adjusting the rig plan, based on the digital twin, to optimize a performance criterion, wherein the performance criterion comprises speed, efficiency, risk, or combinations thereof.

14. The method of claim 13, further comprising:
approving, via an individual or rig controller, an approved version of the rig plan after one or more simulations of the disassembling of the rig via the digital twin.

15. The method of claim 14, further comprising:
assembling the rig components at the rig site based on the approved version of the rig plan.

16. The method of claim 13, further comprising:
performing an actual disassembly of the rig at the rig site;
monitoring an actual performance criterion during the actual disassembly;
comparing the actual performance criterion to a simulated performance criterion of the digital twin; and
identifying differences between the actual performance criterion and the simulated performance criterion.

17. The method of claim 16, further comprising:
modifying the digital twin, based on the differences, to reduce errors between the actual performance criterion and the simulated performance criterion.

18. The method of claim 1, further comprising:
based on the rig plan, operating at least a portion of the rig during at least a portion of the disassembling of the rig.
